(19) United States
(12) Patent Application Publication
(10) Pub. No.: US 2020/0110269 A1
(43) Pub. Date: Apr. 9, 2020

(54) FOLDABLE VIRTUAL REALITY DISPLAY DEVICE

(71) Applicant: Hae-Yong CHOI, Seoul (KR)

(72) Inventor: Hae-Yong CHOI, Seoul (KR)

(21) Appl. No.: 16/590,532

(22) Filed: Oct. 2, 2019

(30) Foreign Application Priority Data
Oct. 5, 2018 (KR) 10-2018-0118811

(51) Int. Cl. G02B 27/01; G02B 27/04; G02B 27/22

(52) U.S. Cl. CPC G02B 27/0176; G02B 27/2257; G02B 27/04

(57) ABSTRACT

A foldable virtual reality display device that includes a central board, which is provided with image displays in the user's viewing direction; first and second hinges provided at the front end and the rear end of the central board; left and right image plates folded toward left and right surfaces of the central board with respect to the first hinge; and left and right lens plates folded toward both left and right surfaces of the central board with respect to the second hinge. When used, the optical axis of the left and right image plates corresponds to the optical axis of the left and right lenses, and simultaneously corresponds to the focal distance between the left and right lenses, and when carried, the left and right image plates and the left and right lens plates are folded with respect to the both left and right surfaces of the central board.

### CROSS-REFERENCE TO RELATED APPLICATION

This application claims under 35 U.S.C. § 119(a) the benefit of Korean Patent Application No. 10-2018-0118811 filed on Oct. 5, 2018, the entire contents of which are incorporated herein by reference.

### BACKGROUND

### (a) Technical Field

The present invention relates to a foldable virtual reality image device provided with two image displays and the entire structure of the device is folded.

### (b) Background Art

The present invention is invented by developing and improving U.S. Pat. No. 9,804,401 “PORTABLE VIRTUAL REALITY DEVICE” filed and registered by the applicant of the present application so that it is provided with the left and right image displays to enlarge the left and right viewing angles without a smart phone, but it is configured to be portable by folding it.

The conventional virtual reality video device for a headset, which is equipped with a smart phone, is configured to have a separate smart phone and a structure for viewing virtual reality images provided by the smart phone.

Accordingly, there is an inconvenience of having to prepare a separate smart phone when using it for promotional use, experimental use, educational use, or work site use.

In addition, the virtual reality video device using a smart phone had a side effect that since a screen of a 16:9 aspect ratio is divided into two screens of 8:9 for a three-dimensional image, and then combined into a single image to watch a three-dimensional video, the left and light viewing angles are significantly reduced to ½.

### PRIOR ART DOCUMENT

### Patent Document

(Patent Document 1) U.S. Pat. No. 9,804,401

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art, and provides a foldable virtual reality display device.

A foldable virtual reality display device of the present invention includes: a position sensor, such as a gyro sensor, provided at a video display position; left and right lenses provided at a position where an image display divided into the left and the right corresponds to a center of an image on an image plate divided into the left and the right and an optical axis, and divided into the left and the right; and a central board 1 having a length which corresponds to a focal distance between the left and right lenses, wherein the image display and the left and right lenses 5, 5a, which are divided into the left and the right, are folded toward both left and right surfaces of the central board 1, the optical axes of the left and right lenses and the left and right images are configured to be corresponded.

That is, the present invention is characterized in that it is transformed into a thin plate shape when carried while having an image display.

### Effects of the Present Invention

The effect of the foldable virtual reality display device according to the present invention will be described as follows.

When used, the left and right image plate provided in a first hinge structure and the left and right lens fixing plate provided in a second hinge structure are unfolded in the direction of 90° with respect to the front and rear directions of the central board, respectively, and thus are unfolded in the horizontal direction of 180°.

When carried, the left and right image plate and the left and right lens fixing plate are folded in the direction of 90°, respectively, and thus are folded to both left and right surfaces of the central board formed in a thin plate shape.

Therefore, when used, the left and right images and the left and right lenses are unfolded on the same optical axis in parallel with each other, and when carried, the entire structure is transformed into a thin plate shape.

In addition, the left and right lenses are provided to have a focal distance, which is the same length as the central board, so that the focal distance may be automatically matched.

By matching the left and right lenses with the left and right display structure and the optical axis, three-dimensional images which do not generate multiple phases are viewed.

The present invention provides a left and right viewing angle which is two times wider than the conventional viewing angel by magnifying existing screens of 8:9 having narrow left and right viewing angles to a 16:9 screen,

By dividing the resolution of a conventional screen by two, it is possible to increase the resolution of images that is lowered by more than two times.

Therefore, while the present invention is provided with an image plate structure, it is easy to carry and use by greatly reducing its volume and weight by more than ⅕ to 1/10 in volume and by more than ⅓ to 1/9 in weight as compared to a conventional headset VR device with an image structure.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a foldable virtual reality image device according to the present invention.

FIG. 2A is a perspective view showing a state that a foldable virtual reality image device according to the present invention is unfolded.

FIG. 2B is a perspective view showing a state that a foldable virtual reality image device according to the present invention is folded.

FIG. 3 is a perspective view showing a state that the user is wearing a foldable virtual reality image device according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, reference will now be made in detail to various embodiments of the present disclosure, examples of which are illustrated in the accompanying drawings and described below.

As shown in FIGS. 1, 2, and 3, the present invention includes: a central board 1 in a thin plate shape, which is provided with an image display in the user's viewing direction; a first and a second hinges 2, 3 provided at the front end and the rear end of the central board 1; left and right image plates 6, 6a folded and unfolded in the direction of both left and right surfaces of the central board 1 with respect to the first hinge 2; and left and right lens plates 4, 4a folded and unfolded in the direction of both left and right surfaces of the central board 1 with respect to the second hinge 3, wherein, when used, the optical axis of the left and right image plates 6, 6a corresponds to the optical axis of the left and right lenses 5, 5a, and simultaneously corresponds to the focal distance between the left and right lenses, and when carried, the left and right image plates 6, 6a and the left and right lens plates 4, 4a are folded with respect to both left and right surfaces of the central board 1 to be easily portable.

In particular, if the optical axis of the left and right image plates 6, 6a does not correspond to the optical axis of the left and right lenses 5, 5a, multiple phases occur during use, and thus the image cannot be used.

In addition, if the focal distance between the left and right lenses 5, 5a does not correspond to the length of the central board 1, the focal distance between the left and right lenses 5, 5a is not matched, and thus the images cannot be used.

The left and right image display 7, 7a structure is provided with an image display having a self-luminous structure such as LCD, OLED, QLED, and MICRO LED.

The position sensor 9 includes a gyro sensor, an acceleration sensor, a geomagnetic field sensor and the like. The gyro sensor measures the tilted angle to detect the movement of the top, bottom, left, and right of the present invention. The geomagnetic field sensor serves to detect the strength and weakness of a magnetic field and supplement the gyro sensor. The acceleration sensor is combined with the gyro sensor to capture the motion of the present invention. Accordingly, one position sensor 9 system is formed by adding a sensor for detecting an image corresponding to a viewing angle which rotates depending on the rotational movement direction of the left and right image displays 7, 7a such as a gyro sensor, a geomagnetic field sensor, and an acceleration sensor form, which needs to be provided in the same direction as the left and right image display 7, 7a device rotates.

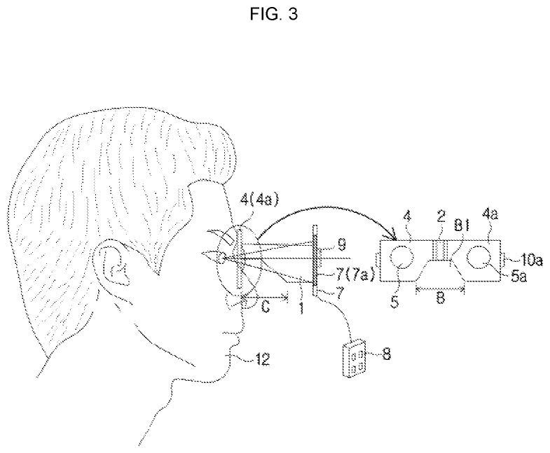

That is, when the user 14 wears the present invention and rotates to the left as shown in FIG. 3, the position sensor 9 may detect a left side viewing angle image from entire viewing angle images of 360°, a right side viewing angle image when the user rotates to the right, and an up and down viewing angle image when the user rotates vertically, and provide an image of the relevant viewing angle.

As shown in FIG. 1, a central board 1 is provided with a first hinge 2 at the front portion thereof and a second hinge 3 at the rear portion thereof with respect to a main body. That is, one central board 1 is provided with two hinges on the front and rear surfaces thereof.

The first hinge 2 connects a left lens fixing plate 4 and a right lens fixing plate 4a, which are rotated vertically and folded toward both left and right surfaces of the central board 1, respectively, and thus the left lens fixing plate 4 is provided with the left lens 5 and the right lens fixing plate 5 is provided with the right lens 5a, respectively.

The second hinge 3 connects a left image fixing plate 6 and a right image fixing plate 6a, which are rotated vertically and folded toward both left and the right surfaces of the central board 1, respectively, and thus the left and right image fixing plates 6, 6a are provided with the left image plate 7 and the right image plate 7a, respectively.

A position sensor 9 such as a gyro sensor for measuring the position of an image is provided at the rear end of the left and right image plates 7, 7a or the central board 1.

In the present invention as described above, it is important that the left and right lens plates 4, 4a and the left and right image displays 7, 7a are provided at a position where respective optical axes thereof correspond to each other so as not to occur multiple phases of the virtual reality image during use.

The length of the central board 1 is configured to be equal to the focal distance between the left and right lenses 5, 5a. That is, the distance between the left and right lenses 5, 5a is configured to be equal to the distance between the left and right lenses 5, 5a and the image surface of the left and right image plates 7, 7a.

For example, if the focal distance between the left and right lenses 5, 5a is 50 mm, the length of the central board 1 is also set as 50 mm.

An interval between the optical axes of the left and right image plates 6, 6a unfolded when used is fixed as 63 to 65 mm. Therefore, the width of a screen will be within 126 to 130 mm.

In addition, an interval between the optical axes of the left and right lenses 5, 5a and the left and right lens plates 4, 4a unfolded when used is also configured to be the same, so that the interval between the left and right eyes of a person corresponds to the optical axis of the left and right image plates 6, 6a and the optical axis of the left and right lenses 5, 5a, thereby watching the VR stereoscopic image.

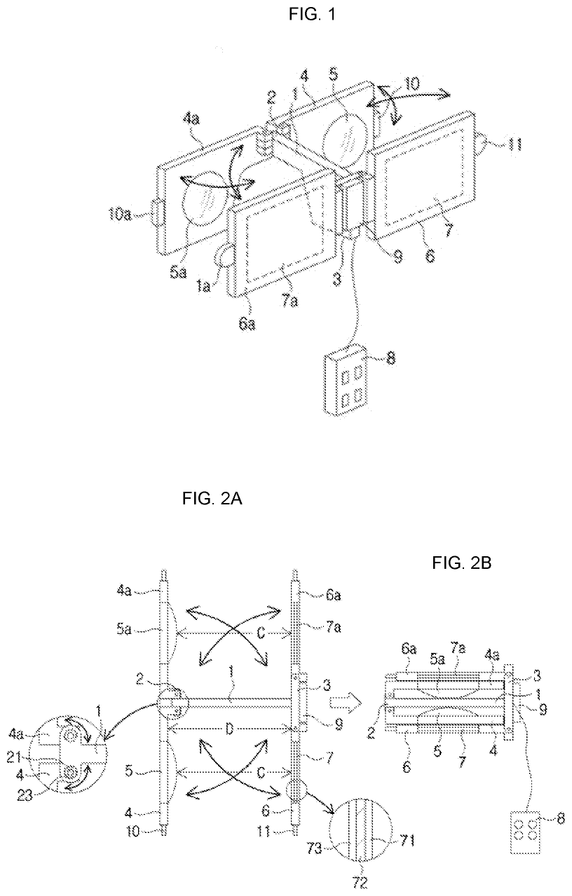

As shown in FIG. 2A, the left and right lens plates 4, 4a are folded by the first hinge 2, and the left and right image plates 6, 6a are folded by 0° toward both the left and right surfaces of the central board 1 by the second hinge. The order in which the left and right lens plates 4, 4a and the left and right image plates 6, 6a are folded may be selectively configured.

According to the present invention as shown in FIG. 2A, when using, the left and right image plates 6, 6a and the left and right lens plates 4, 4a are unfolded horizontally by 180° with respect to the central board 1, respectively, and are folded to form a thin plate structure as shown in FIG. 2B with respect to the central board 1 when carrying.

In the structure of the present invention as shown in FIG. 2A, if the left and right lens plates 4, 4a provided with the left and right image plates 6, 6a are unfolded, respectively, since the left lens 5 and the left image plate 6, and the right lens 5a and the right image plate 6a have the same optical axis C, respective focal points correspond to each other.

In addition, as shown in FIG. 2A, the focal points may be automatically matched by forming the focal distance between the left and right lenses 5, 5a to be the same as the length D of the central board 1.

A wearing space B in which the nose of the user 12 can be entered needs to be formed between the left and right lenses 5, 5a as shown in FIG. 3, and the fixing device (not shown) such as handles 10, 10a, glasses legs, band or the like may be added to both the left and right ends of the left and right lens plates 5, 5a.

As shown in FIG. 2A, the first and the second hinges 2, 3, to which a locking device (not shown) to fix the rotation position at a predetermined position is added, are engaged by gears formed on the left and right rotation shafts 23, 24 to be rotated.

The left and right image displays 7, 7a provided in the left and right image plates 6, 6a may be formed in various screen ratios such as 8:9, 16:9, 32:9 and the like.

The left and right image displays 7, 7a may be formed with an image display 71 provided with a self-luminous panel 73 structure such as LCD, OLED, QLED, and micro LED having a self-luminous source, as shown in FIG. 2.

In the present invention, an image input, a power supply, and image control may be performed by a separate control device 8 as shown in FIGS. 1 and 3, and a separate power adapter and a battery may be provided.

While the foldable virtual reality display device according to the present invention is used as shown in FIG. 2A, since it may be folded and transformed to the smallest volume of portable VR display device as shown FIG. 2B, the size when carrying may be reduced to 6.5 cm×3 cm×6.5 cm=about 127 cm³ up to a maximum 8 cm×5 cm×8 cm=about 320 cm³ and the weight up to 50 to 160 g.

The structure of the present invention may be significantly reduced to more than ⅕ to 1/10 in volume and by more than ⅓ to 1/9 in weight, as compared to the normal size, 12 cm×10 to 20 cm×20 cm=2400 cm³ to 4800 cm³, the normal weight, 300 to 470 g of a normal VR headset equipped with existing video displays, and thus is portable.

In addition, the viewing angle of a conventional device using a smart phone which is divided by two, that is, the viewing angle is magnified twice to a 16:9 screen compared to an 8:9 screen.

Further, since the position sensor 9 is provided at a position at which the left and right image displays 7, 7a rotate, it is possible to provide a virtual reality image of the corresponding viewing angle provided by the viewing angle of 360° up, down, left, and right according to the user's rotation.

Therefore, since the present invention is a minimum volume of VR device having a pocket structure, it is possible to watch the virtual reality image at any time regardless of the place without a separate smart phone by carrying it.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A foldable virtual reality display device, comprising:
a central board in a thin plate shape, which is provided with image displays in the user's viewing direction;
a first and a second hinges provided at the front end and the rear end of the central board;
left and right image plates folded toward both left and right surfaces of the central board with respect to the first hinge and unfolded;
left and right lens plates folded toward both left and right surfaces of the central board with respect to the second hinge and unfolded;
wherein when used, the optical axis of the left and right image plates corresponds to the optical axis of the left and right lenses, and simultaneously corresponds to the focal distance between the left and right lenses, and
when carried, the left and right image plates and the left and right lens plates are folded with respect to both left and right surfaces of the central board to be easily portable.

2. The foldable virtual reality display device according to claim 1, wherein the left and right image display structure is configured as an image display having a self-luminous structure such as LCD, OLED, QLED, and MICRO LED.

3. The foldable virtual reality display device according to claim 1, wherein at least a gyro sensor is provided in a position sensor.

4. The foldable virtual reality display device according to claim 1, wherein one among handles, glasses legs, and a band is further provided at both left and right ends of the left and right lens plates.
